(19) United States
(12) Patent Application Publication
(10) Pub. No.: US 2006/0051584 A1
(43) Pub. Date: Mar. 9, 2006

(54) Process for producing a product having a structured surface

(76) Inventors: Florian Bieck, Mainz (DE); Jurgen Leib, Freising (DE); Dietrich Mund, Obersussbach (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/511,488

(22) PCT Filed: Apr. 15, 2003
(86) PCT No.: PCT/EP03/03873

§ 371 Date: May 26, 2005

(30) Foreign Application Priority Data
Apr. 15, 2002 (DE) 202 05 830.1
May 23, 2002 (DE) 102 22 958.9
May 23, 2002 (DE) 102 22 964.3
May 23, 2002 (DE) 102 22 609.1
Nov. 13, 2002 (DE) 102 52 787.3
Jan. 16, 2003 (DE) 103 01 559.0

(51) Int. Cl. H05H 1/24; B32B 9/00; B32B 17/10; B32B 17/06; B29B 7/00

(52) U.S. Cl. 428/408; 427/569; 428/432; 428/542.8; 428/701; 428/409

(57) ABSTRACT

The invention is based on the object of providing a process for producing microstructures in glass or layers similar to glass.

For this purpose, an auxiliary substrate (10, 20) having a structured surface (20a). is used, the surface defining a negative mold for the product which is to be produced. Then, a layer (30) of glass or a material similar to glass is applied to the structured surface (20a) of the auxiliary substrate by evaporation coating. Then, the auxiliary substrate is removed, for example by wet-chemical means, in such a way that the positive structure is uncovered. The invention makes it possible to produce excellent micro-channels and optical microstructures, such as micro-lenses.

The invention relates to a process for producing a product having a structured surface, and to products of this type in general, and to a process for generating microstructures in glass in particular.

Glass is valued and used for a wide range of applications, partly on account of its excellent optical and chemical properties. By way of example, glasses are highly resistant to water, water vapor and in particular also to aggressive substances, such as acids and bases. Furthermore, by using different compositions or additives, glasses can be made extremely variable and can therefore be matched to a wide range of application areas.

One major application area for glasses is optics and opto-electronics. By way of example, it is nowadays inconceivable not to use optical components in the field of data transmission.

In particular in this application area, the components are becoming ever smaller, and consequently the demands imposed on the accuracy of the components are constantly rising. By way of example, there is a high demand for light-influencing, e.g. refractive or diffractive, components of an extremely high optical quality. At this point, mention can be made, purely by way of example, of optical micro-lenses.

On account of its excellent optical properties, glass is eminently suitable for this purpose. On the other hand, however, glass presents certain difficulties in use. For example, accurate machining, in particular precision structuring, of glass presents problems.

Although it is known to etch glasses by wet-chemical or dry-chemical means, in particular in the case of glasses it is in this case only possible to achieve low etching rates, and consequently a process of this type is also slow and accordingly too expensive for mass production.

By way of example, it is also known to use photo-structurable glasses, such as for example FOTURAN®. However, glasses of this type are extremely expensive.

Accurate structures can also be produced on glasses using a laser, but this technique too is very slow and likewise too expensive for mass production.

Furthermore, there are various known mechanical machining processes, e.g. grinding and polishing, but such processes do not generally allow the accuracy and precision which can be achieved with other processes.

Therefore, the invention is based on the object for providing a process which allows simple and inexpensive production of a product having a structured surface.

A further object of the invention is to provide a process for producing a product having a structured surface which allows accurate, precisely positionable and/or diverse structuring.

Yet another object of the invention is to provide a process for producing a product having a structured, in particular micro-structured, surface which is suitable for glass or a material with a vitreous structure, without being restricted to such materials.

Yet another object of the invention is to provide a process for producing a product having a structured surface which is suitable for mass production and avoids or at least reduces the drawbacks of the prior art.

The object of the invention is achieved in a surprisingly simple way simply by means of the subject matter of the independent claims. Advantageous refinements of the invention are defined in the subclaims.

The invention provides a process for producing a product having a surface which is structured in a predefined way, in particular for generating microstructures, e.g. micro-lenses and/or micro-channels in or from glass. The process at least comprises the steps of providing an auxiliary substrate, structuring at least one surface of the auxiliary substrate and applying a first layer of a first material to the structured surface of the auxiliary substrate.

In the context of the present invention, the structured surface of the auxiliary substrate is not necessarily to be understood as meaning the actual structured surface of the auxiliary substrate, but rather may also encompass the structured surface of a layer applied to the auxiliary substrate. Nonetheless, the auxiliary substrate may, however, also be structured directly (cf. FIGS. 4a, 4b, 4c).

The use of an auxiliary substrate, if appropriate with further layers, as the structure-defining element has proven highly advantageous for the invention, since the material of this substrate can be selected and adapted on the basis of the structurability properties. In particular, the auxiliary substrate does not necessarily have to be transparent, since it is removed again and is therefore not part of the finished product. The removable auxiliary substrate may if appropriate even be reusable and may therefore contribute further to reducing costs.

Accordingly, the auxiliary substrate is in particular detached or removed again from the first layer or from the product, preferably after application of the first layer, if appropriate after further process steps. In other words, the first layer can be detached or separated from the auxiliary substrate while retaining the structured surface.

In particular, therefore, in the process according to the invention a negative mask or mold having a surface which has been structured in predefined form is provided, and the first layer is deposited on the negative mask in order to produce a positive impression of the structured surface of the negative mask in the first layer.

It is preferable for a self-supporting carrier or a product substrate made from a third material, in particular from glass, a material with a vitreous structure or another, in particular transparent, material to be applied to the first layer.

It will be clear at this point that the process according to the invention for producing a structured layer on a substrate, in particular the product substrate, represents an extremely surprising approach, since the layer is not, as in conventional processes, grow away from the product substrate, but rather, with respect to the product which is to be produced, grows toward the product substrate, since the negative technology used means that the structured layers grows on the auxiliary substrate.

The process according to the invention is particularly advantageous because it is therefore simple, fast and inexpensive to generate microstructures in glass. Furthermore, it is possible to produce very small, in particular diffractive or refractive structures, e.g. micro-lenses or micro-channels, in the layer surface, with the surface of the auxiliary substrate defining corresponding negative molds.

Furthermore, the surface structure can be accurately predetermined and controlled by means of the negative technique employed, so that it is possible to achieve a uniform product quality and a high surface quality.

It is preferable for the first material to be glass or a material similar to glass, so that it is possible to produce a glass layer structured in predefined form having the benefits outlined above. The provision according to the invention of microstructures, e.g. micro-lenses, made from glass, a material similar to glass or another transparent material, open up an enormous range of potential applications in the field of glass fiber-optics.

A suitable layer which is similar to glass is in particular an SiO₂ layer which is deposited by means of CVD (chemical vapor deposition) and, by way-of example, is doped with phosphorus and/or boron. Phosphorus and boron are likewise deposited from the vapor phase. The advantage of a layer of this type is that the reflow temperature is lower than in the case of glass.

It has turned out that an additional, unexpected benefit of the invention is that a product which has been structured in accordance with the invention is eminently suitable for use in micro-fluidics. In this context, it is particularly advantageous that the glass layer provided with micro-channels is distinguished by a high chemical stability.

Glass is distinguished by a high variability in terms of its thermal, mechanical and optical properties.

It is particularly preferable for the first layer or glass layer to be deposited on the auxiliary substrate, in particular by evaporation coating. Electron beam evaporation coating processes or sputtering processes have proven particularly suitable. In this context, it is preferable for an evaporation-coating glass, e.g. evaporation-coating glass 8329 produced by Schott, to be heated in a vacuum chamber by means of an electron beam until it evaporates, with the vapor precipitating and vitrifying on the auxiliary substrate.

In this respect, reference is also made to the applications
DE 202 05 830.1, filed on Apr. 15, 2002
DE 102 22 964.3, filed on May 23, 2002;
DE 102 22 609.1, filed on May 23, 2002;
DE 102 22 958.9, filed on May 23, 2002;
DE 102 52 787.3, filed on Nov. 13, 2002;
DE 103 01 559.0, filed on Jan. 16, 2002
   in the name of the same Applicant, the content of disclosure of which is hereby expressly incorporated by reference.

The following process parameters are advantageous for the application of a continuous layer of glass:

| | | |
|---|---|---|
| Surface roughness of the substrate: | <50 | μm |
| BIAS temperature during the evaporation: | ≈100° | C. |
| Pressure during the evaporation: | 10⁻⁴ | mbar |

It is advantageous for the deposition or application by evaporation coating of the first layer to be carried out by means of plasma ion assisted deposition (PIAD). In this case, an ion beam is additionally directed onto the substrate which is to be coated. The ion beam can be produced by means of a plasma source, for example by ionization of a suitable gas. The plasma produces additional densification of the layer and is also responsible for detaching particles adhering loosely to the substrate surface. This leads to particularly dense, low-defect layers being deposited.

According to a preferred refinement of the invention, the first layer is planarized, e.g. chemically and/or mechanically, after it has been applied or deposited. Suitable processes for this purpose include wet-chemical etching or grinding and/or polishing of the glass layer. The product substrate is in this case preferably applied following the planarization.

It is preferable for the product substrate, which is in particular self-supporting and provides stability to the product, to be applied to the in particular planarized first layer or glass layer. In this case, the product substrate is, for example, anodically bonded to the first layer. Anodic bonding has the advantage that the product produced can be subjected to high chemical loads.

As an alternative or in addition, the product substrate is adhesively joined to the first layer. In particular in this case, the planarization may advantageously be omitted, since the adhesive is able to compensate for unevenness. In this example, the planarization is effected, as it were, by the adhesive. This simple embodiment is particularly suitable for nonoptical products, i.e. for example products for micro-fluidics. The adhesive used is, for example, an epoxy, in particular a transparent epoxy.

Both during anodic bonding and during adhesive joining using epoxy, a fixed and permanent sandwich-like composite comprising the product substrate, the first layer or glass layer and the joining layer, embodied by anodic bonding or the epoxy, results after the removal of the auxiliary substrate, as an intermediate or end product, producible or produced by the process according to the invention.

In particular, the product substrate and/or the first layer are transparent, so that the composite is in particular permeable or transparent to light, preferably in the visible or infrared region. In other words, according to the invention an optical, e.g. refractive or diffractive, composite element is produced. Therefore, the invention can be used, for example, to produce whole arrays of micro-lenses.

As an alternative or in addition, it is preferable for further layers, such as for example an antireflection coating and/or an infrared-absorbing layer, to be applied, in particular to the planarized first layer, i.e. between the first layer and the product substrate. A layer or layers of this type may, however, also be applied to the product substrate on a side of the latter which is on the opposite side from the first layer. In this way, further optical components are integrated.

According to a preferred embodiment of the invention, the auxiliary substrate comprises a self-supporting carrier made from a second material or consists of such a material. The second material used is preferably not a glass, but rather in particular a semiconductor material, e.g. silicon and/or a ceramic and/or a metal, e.g. aluminum and/or a metal alloy.

According to a particular further development of the invention, the auxiliary substrate, or more accurately the second material, is structured directly and consequently further layers do not necessarily have to be applied, although they may be applied, prior to the deposition of the glass layer. In particular in this refinement, the auxiliary substrate is planarized, in particular by chemical or mechanical means, e.g. by plane-lapping, before or if appropriate after the structuring step.

To uncover the glass structure following the deposition of the glass layer, it is preferable for the auxiliary substrate, in particular the second material, to be substantially completely or at least partially etched away. By way of example in the case of a silicon auxiliary substrate, the latter is dissolved chemically by means of potassium hydroxide (KOH).

As an alternative or in addition to the embodiment described above, according to a further embodiment the auxiliary substrate comprises a self-supporting carrier made from a second material and a structuring layer which is applied to the carrier. In this case, it is preferable for the structuring layer rather than the carrier to be structured.

The structuring layer comprises or consists of in particular resist or photoresist. A gray scale resist is used in particular to produce analog structures, e.g. lenses. Following the deposition of the glass layer, the structuring layer is then etched away completely or at least partially, in particular by being dissolved chemically.

According to a preferred refinement of the invention, at least one or more intermediate layers are also arranged between the carrier and the structuring layer. The intermediate layer or layers preferably comprise or consist of a resist. In particular, the resist of the intermediate layer and the resist of the structuring layer are made from different materials, so that they can be etched away selectively.

In a particularly preferred embodiment, the auxiliary substrate or the structuring layer is structured by lithographic means. As an alternative or in addition, however, it is also possible for the structuring to be produced mechanically, for example by pressing, in particular into a film or foil, by means of a precision master. Even with this simple process, it is possible to achieve accuracies in the micrometer range.

For structures with relatively low demands on accuracy, the structuring may, for example, be produced by means of screen printing.

The application or adhesive joining of a film or foil which has already been pre-structured or microstructured, to the auxiliary substrate is particularly simple and therefore preferred.

Furthermore, the invention is also related to the inventions which are described in German utility model application U-202 05 830.1, filed on Apr. 15, 2002, and German patent application DE-102 22 609.1, filed on May 23, 2002. Therefore, the content of the two applications referred to above is hereby incorporated in full by reference in the subject matter of the present disclosure.

In the text which follows, the invention is explained in more detail on the basis of exemplary embodiments and with reference to the drawings.

### BRIEF DESCRIPTION OF THE FIGURES

FIGS. 1a-i show the production of a product according to the invention in accordance with a first embodiment of the invention,

FIGS. 2f-g show the production of a product according to the invention in accordance with a second embodiment of the invention,

FIGS. 3a-f show the production of a product according to the invention in accordance with a third embodiment of the invention,

FIGS. 4a, c, d show the production of a product according to the invention in accordance with a fourth embodiment of the invention, and

FIGS. 5f-g show the production of a product according to the invention in accordance with a fifth embodiment of the invention,

FIGS. 6a, d, f show the production of a product according to the invention in accordance with a sixth embodiment of the invention,

FIG. 7 shows results of a TOF-SIMS measurement,

FIG. 8 shows a photograph of a microscope image, and

FIG. 9 diagrammatically depicts a wafer with a hole mask for a leak tightness test.

### DETAILED DESCRIPTION OF THE INVENTION

The following text presents, by way of example, six embodiments of the invention; it is possible for the features of the various embodiments to be combined with one another.

The drawings show diagrammatic sectional illustrations through the product in the corresponding production stage. For the sake of clarity, figures which show identical or similar production stages are denoted by the same letters, and consequently some letters have been omitted in the numbering of the figures. Identical and similar parts are provided with the same reference symbols in the figures.

### EXAMPLE 1

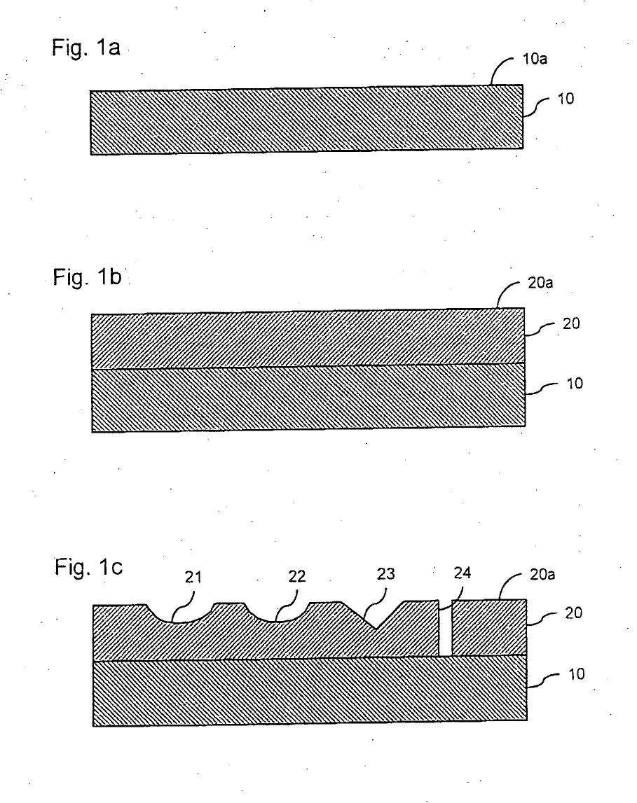

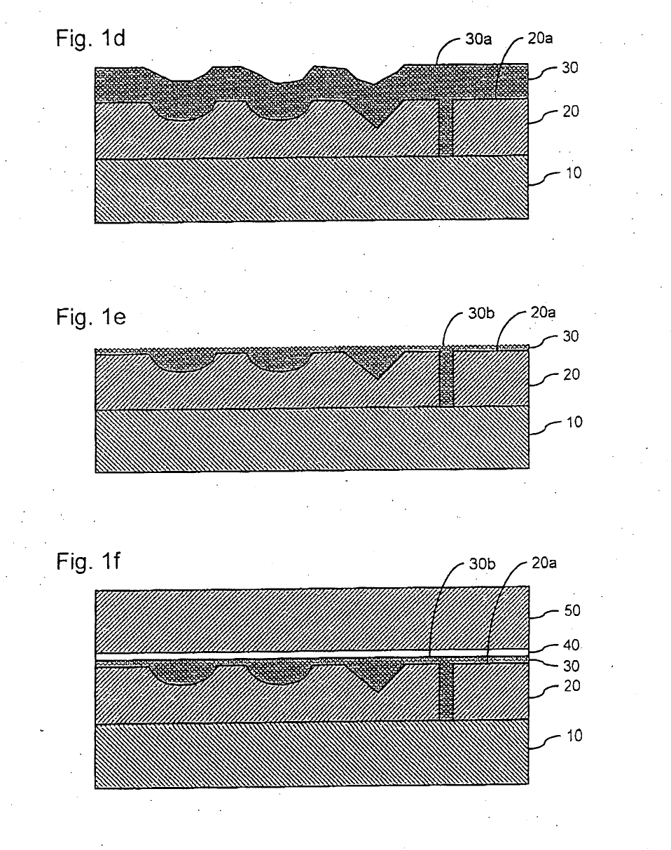

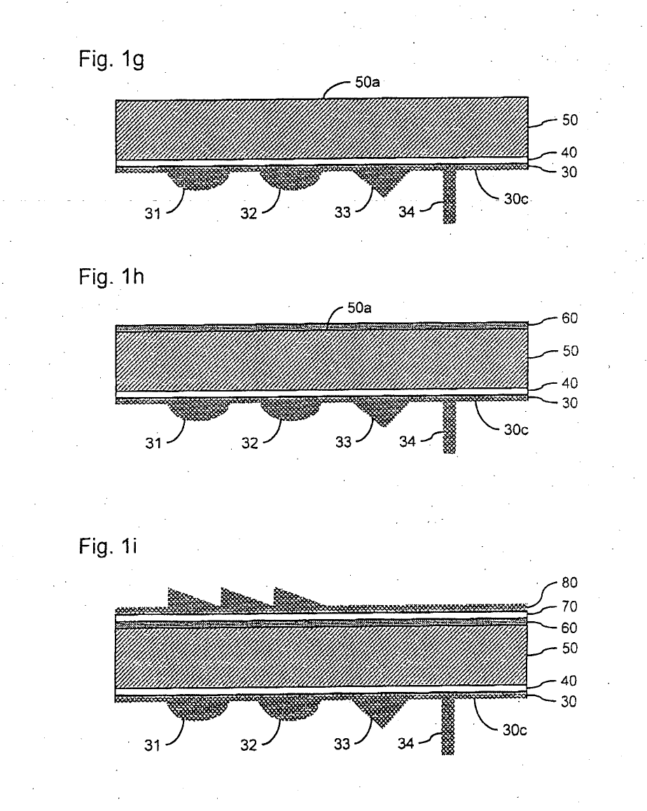

FIG. 1a shows an auxiliary substrate 10 made from silicon. According to the next process step, illustrated in FIG. 1b, a layer of photoresist, more specifically of gray scale resist 20, is applied to a topside 10a of the substrate 10. The gray scale resist has the advantage that it is also possible to produce analog structures.

As illustrated in FIG. 1c, the gray scale resist 20 is provided with structures 21 to 24 by means of gray scale lithography. The structures 21 and 22 represent two rotationally symmetrical hollows which are designed as a negative mold for two convex lenses. The structure 23 forms the negative mold for a triangular structure, and the structure 24 represents the negative mold for a rectangular binary diffractive structure.

As illustrated in FIG. 1d, a first layer or glass layer 30 is deposited on a topside 20a of the resist 20 by means of PVD (physical vapor deposition). In this example, the evaporation-coating glass 8329 produced by Schott Glas is used as material for the glass layer 30. As an alternative, however, it is also possible to use virtually any other glass which is suitable for evaporation coating. However, it is also possible to deposit materials other than glass, such as for example Al₂O₃ or SiO₂.

To smooth the uneven surface 30a of the glass layer 30, as shown in FIG. 1d, this surface is planarized.

In the present exemplary embodiment, the planarization is effected by grinding and polishing the glass layer 30 on that side 30a of the glass layer 30 which is remote from the auxiliary substrate 10. As a result, the glass layer 30 acquires a smoothly polished surface 30b. The result following the planarization step is illustrated in FIG. 1e.

As shown in FIG. 1f, a produce substrate 50, which is not identical to the auxiliary substrate 10, is anodically bonded to the glass layer 30 at its surface 30b, the bonding being denoted by reference numeral 40 in FIG. 1f.

The product substrate 50 used is, for example, a drawn glass, in particular D263 produced by Schott. Depending on the particular application, an alkali-free glass, e.g. AF45, AF37, produced by Schott, may also be advantageous. Alternatively, a float glass, e.g. Borofloat 33 produced by Schott, known under the trade name “Jenaer Glas” is used. The product substrate 50 is self-supporting and serves to stabilize the product which is to be produced, and consequently in this example the glass layer 30 is not self-supporting, although it may be self-supporting if required.

Then, the auxiliary substrate 10 and the gray scale resist 20 are removed by etching away the gray scale resist, so that, as illustrated in FIG. 1g, all that remains is the product substrate 50, the glass layer or glass structure 30 and the anodic bonding 40. The glass layer 30 has positive structures 31 to 34 which are complementary to the negative structures 21 to 24. The positive structures comprise two rotationally symmetric convex lenses 31, 32 with a diameter of approximately 1 mm, a triangular projection 33 and a rectangular structure 34. The structures 33 and 34 extend perpendicular to the plane of the drawing. It will be clear to the person skilled in the art, however, that the process according to the invention can also be used to produce virtually any other desired binary and non-binary structure in the glass layer 30. In particular, it is possible to produce structures of smaller than 500 μm, 200 μm, 100 μm, 50 μm, 20 μm or 10 μm.

The product as illustrated in FIG. 1g consequently already represents an optically transparent product having a microstructured surface. According to this exemplary embodiment, however, the product is processed further, as shown in FIGS. 1h and 1i, in order to obtain a product with two or double-sided structured surfaces.

Referring to FIG. 1h, an antireflection coating 60 is applied to the topside 50a, remote from the glass layer 30, of the product substrate 50. As an alternative or in addition, it is also possible, for example, to apply an infrared-absorbing layer and/or further optical layers.

It is illustrated in FIG. 1i that a second structured glass layer is applied to the antireflection coating 60 by means of anodic bonding 70. The second structured glass layer 80 is produced using the same process as the first structured glass layer 30. In this context, it may be advantageous for the second structured glass layer 80 to be applied to the antireflection coating 70 together with the associated photoresist and auxiliary substrate (not shown), i.e. in a stage corresponding to FIG. 1e, and for the photoresist and auxiliary substrate (not shown) associated with the second glass layer 80 only to be etched away thereafter.

Alternatively, the second structured glass layer 80 may also be applied to the product substrate 50 before the auxiliary substrate 10 and the photoresist 20 are etched away from the first structured glass layer 30, i.e. in the stage illustrated in FIG. 1f, if appropriate also with the incorporation of the antireflection coating 60 and/or further layers. This procedure has the advantage that the photoresists and auxiliary substrates associated with the first and second structured glass layers 30, 80 can be etched away simultaneously.

### EXAMPLE 2

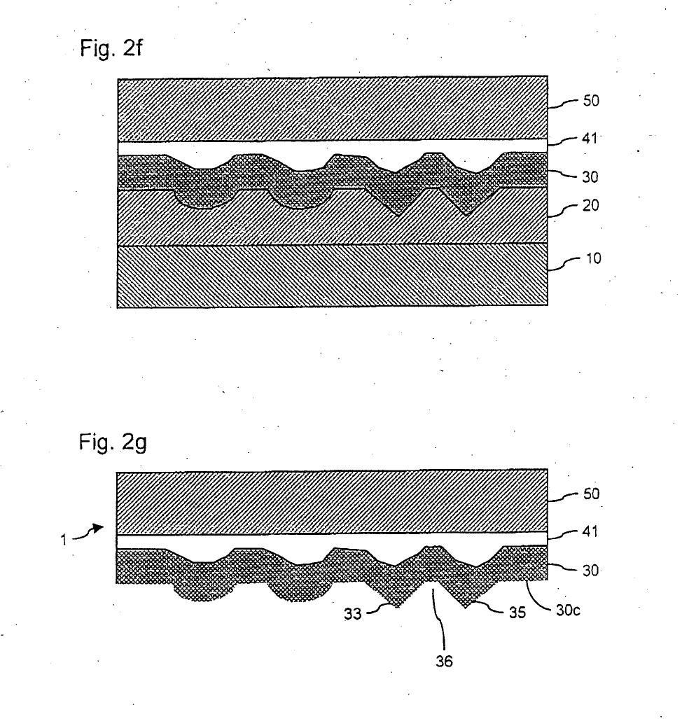

FIG. 2f illustrates a product which has been adhesively joined by means-of a layer of epoxy 41 rather than anodically bonded. Otherwise, the product, up to the stage illustrated in FIG. 2f, has been produced in the same way as in the steps illustrated in FIGS. 1a to 1d.

Therefore, the starting point used for the adhesive joining of the product substrate or carrier 50 is the product prior to the step of planarizing the glass layer 30. The product substrate 50 is adhesively joined to the uneven glass layer 30 by means of the epoxy. As can be seen in FIG. 2f, the epoxy 41 compensates for the unevenness in the glass layer 30.

Referring to FIG. 2g, the auxiliary substrate 10 and the photoresist 20 are etched away as in the first embodiment.

The product 1 illustrated in FIG. 2g also differs from the product shown in FIG. 1d by virtue of having a further triangular binary structure 35 provided instead of the binary structure 34. A micro-channel 36 with a volume in the range from 0.1 to 2 μl is formed between the two triangular structures 33, 35 extending perpendicular to the plane of the drawing. Therefore, the product 1 has eminently suitable for micro-fluidics, e.g. for what is known as a DNA processor, in particular on account of the biological neutrality-of glass.

Since in the product 1 according to the second embodiment of the invention, as illustrated in FIG. 2g, the joining or adhesive layer 41 is not planar on both sides, it has proven advantageous to use an epoxy with a refractive index which is. similar to that of the structured glass layer 30 and of the product substrate 50.

An optical epoxy adhesive, e.g. “Delo-Katiobond 4653” produced by Delo, based on a one-component, solvent-free UV adhesive with a refractive index n=1.5 has proven particularly suitable for use as the epoxy 41.

In the present case, the refractive indices are selected as follows:

| | | |
|---|---|---|
| Product substrate 50 | Glass AF45 | n = 1.52 |
| Epoxy layer 41 | Delo Katiobond 4653 | n = 1.50 |
| Glass layer 30 | Evaporation-coating | n = 1.47 |
| | glass 8329 | |

If Borofloat 33 (n=1.47) or D263 (n=1.52) is used as material for the product substrate 50, the low index differences make it possible to work with the same epoxy. If other glasses are to be used either for the glass layer 30 or the product substrate 50, an epoxy having a corresponding refractive index is selected. Epoxies with refractive indices of from 1.3 to 1.7 are available for this purpose.

### EXAMPLE 3

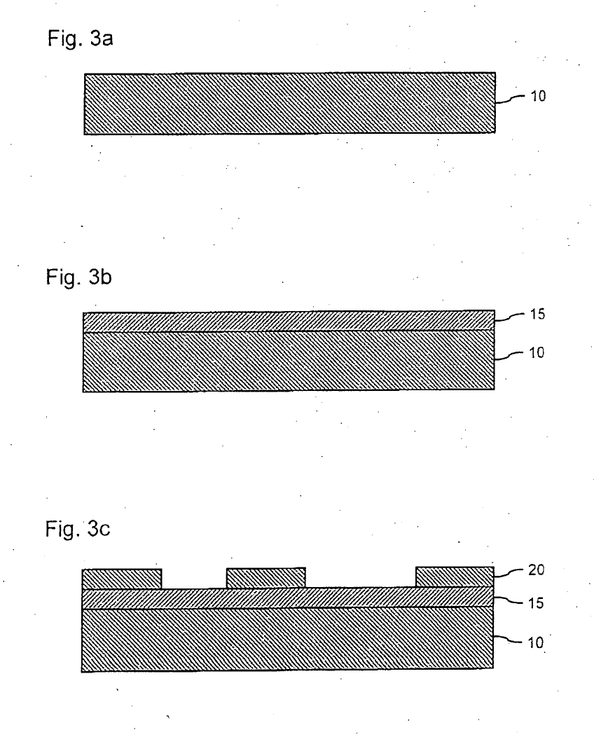

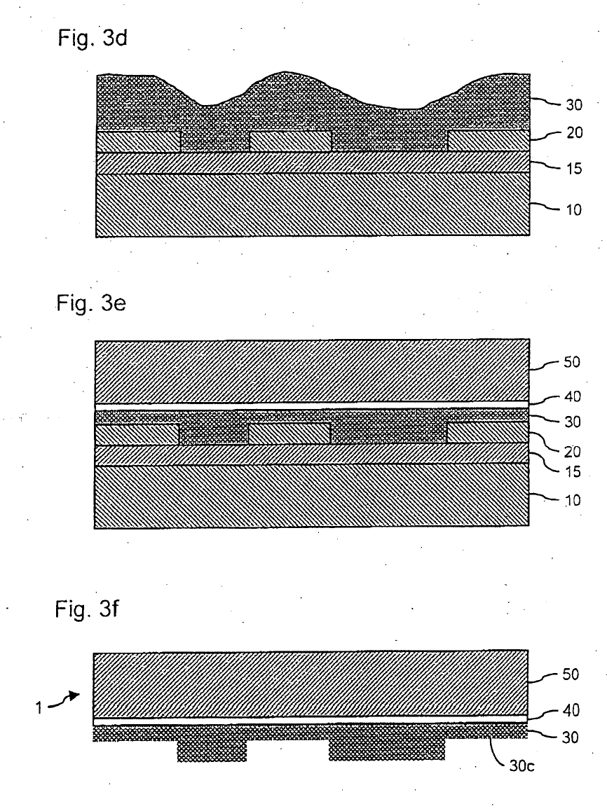

FIGS. 3a-f show the production of the product according to the invention in accordance with a third embodiment of the invention with exclusively binary structures.

First of all, a self-supporting auxiliary substrate 10 made from silicon is provided (FIG. 3a). Then, a first intermediate layer 15 is applied to the auxiliary substrate 10. The intermediate layer 15 may be a photoresist or a simple intermediate layer which is not photosensitive, for example made from a plastics material.

A photoresist layer 20 is applied to the intermediate layer 15 and structured in binary form, for example by means of photolithography. The result is illustrated in FIG. 3c.

Then, a glass layer 30 is applied by evaporation coating (FIG. 3d). The glass layer 30 is planarized and a product substrate 50 is anodically bonded to the planarized glass layer 30 (FIG. 3e).

Then, the auxiliary substrate, the intermediate layer 15 and the photoresist layer 20 are etched away, so that the structured surface 30c of the glass layer 30 is uncovered, and the optical product 1 (FIG. 3f) is the result.

In this case, the intermediate layer 15 prevents adhesive joining of the evaporation-coating glass 30 to the auxiliary substrate 10. Consequently, the embodiment described above is particularly advantageous for the production of binary structures for which a gray scale resist is not used.

### EXAMPLE 4

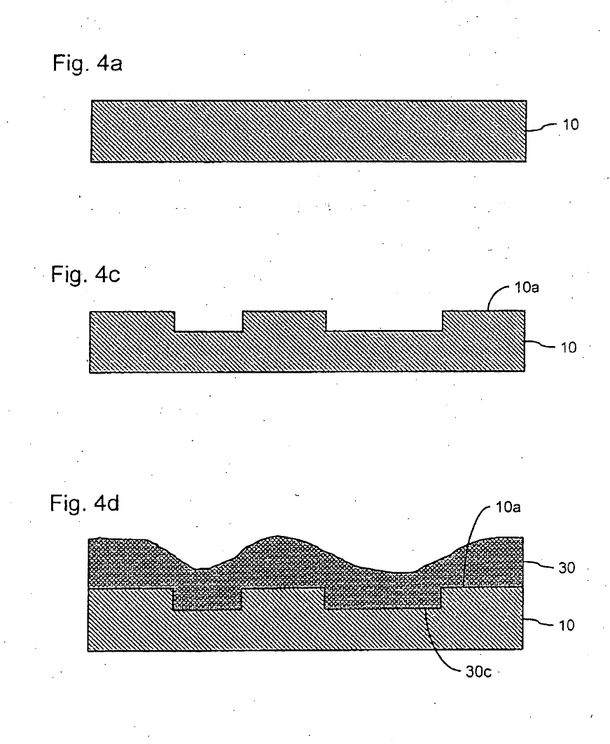

Referring now to FIG. 4a, an auxiliary substrate 10 is provided for the production of a product according to the invention in accordance with a fifth embodiment of the invention. The auxiliary substrate 10 comprises a polished silicon wafer.

Referring now to FIG. 4c, a binary negative structure 10a is produced directly in the auxiliary substrate 10, i.e. in the silicon, by means of wet-chemical etching.

Then, the glass layer 30 is applied by evaporation coating, and the product is processed further in accordance with the other embodiments.

In this exemplary embodiment, the auxiliary substrate 10, more specifically the silicon, is dissolved by means of a KOH solution in order to uncover the structured surface 30c.

### EXAMPLE 5

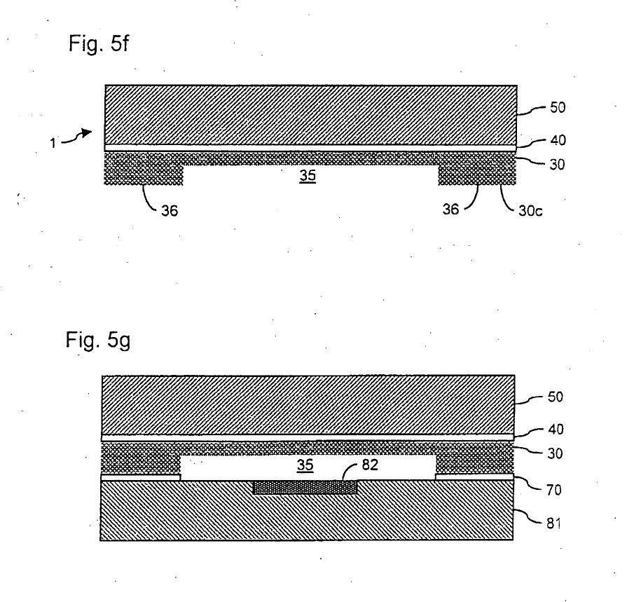

FIG. 5f shows a product according to the invention in accordance with a fourth embodiment in a stage corresponding to FIG. 3f, with a slightly differently structured surface 30c. The surface 30c of the glass layer 30 has a central recess 35 and elevated projections 36 at the outer edge.

Referring now to FIG. 5g, the undersides of the projections 36 of the glass layer 30 on the product 1 are joined to a second project substrate 81 by means of a second anodic bonding 70. This produces a central cavity 35 around an MEMS structure (micro-electro-mechanical system) 82, which is encapsulated by this process.

### EXAMPLE 6

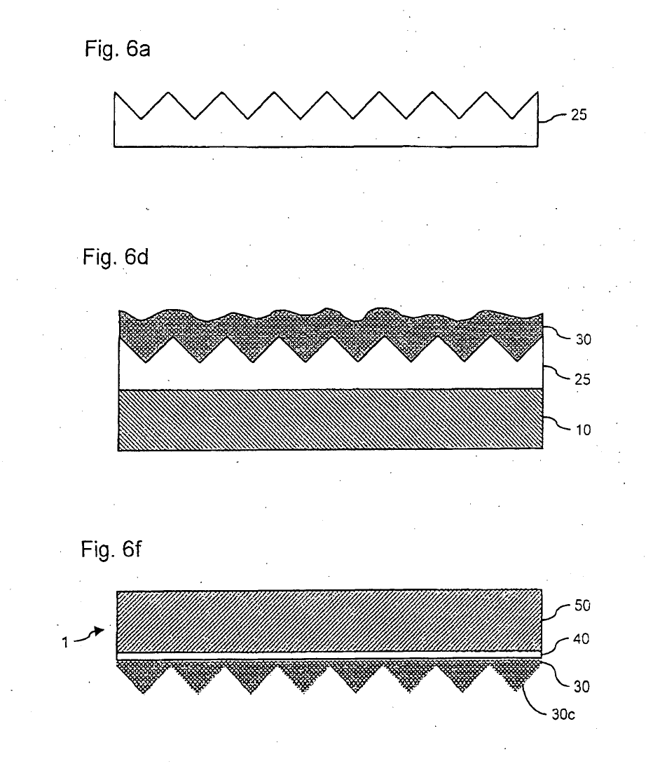

FIG. 6a shows an embossed, pre-structured plastic film 25 as is commercially available off the roll from 3M, by way of example.

The pre-structured film 25 is applied to the auxiliary substrate 10, for example by adhesive bonding (FIG. 6d). Then, the glass layer 30 is applied to the structured surface of the plastic film 25 by evaporation coating.

Referring now to FIG. 6f, the glass layer 30 is ground down and anodically bonded to the product substrate 50. Then, the auxiliary substrate 10 and the plastic film 25 are removed, for example by etching or by being detached in some other way. This in turn produces a completely transparent product 1 having a surface which is structured on one side in the form of the structured glass layer 30 in the glass carrier 50. The following text illustrates results of various tests carried out on glass layers formed from Glas 8329 deposited by evaporation coating.

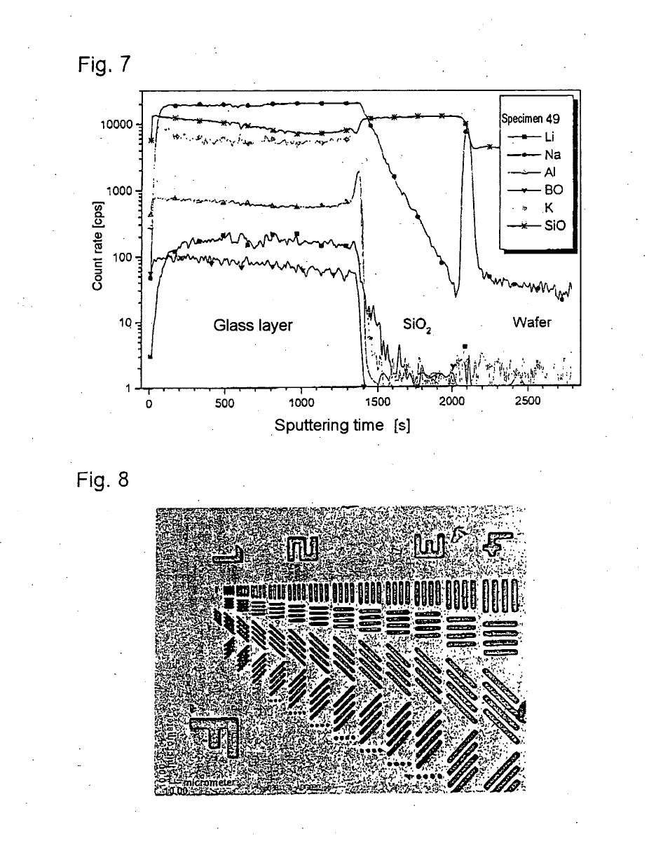

FIG. 7 shows the results of a TOF-SIMS measurement, in which the count rate is plotted as a function of the sputtering time. The measurement characterizes the profile of the element concentrations in the glass layer. A thickness constancy of <1% of the layer thickness was determined for the glass layer.

FIG. 8 illustrates glass structures produced in accordance with the invention from Glas 8329.

Furthermore, leaktightness tests on the copy-protect layer formed from Glas 8329 were carried out as follows.

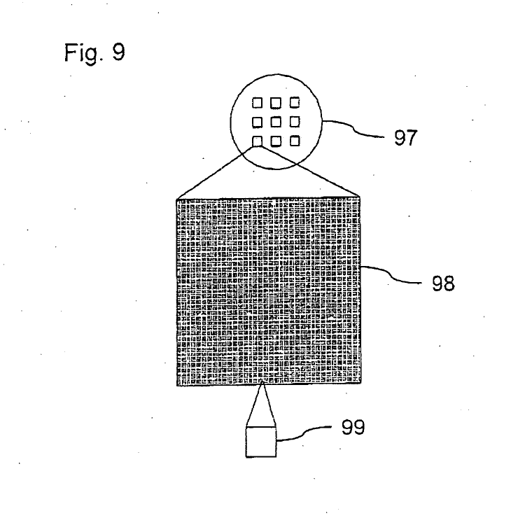

A silicon-wafer was provided with an etching stop mask. As illustrated in FIG. 9, the wafer 97 was divided into nine hole areas 98 (1 cm×1 cm). The individual hole spacing in the areas was varied from row to row as follows.
1st row: 1 mm hole spacing
2nd row: 0.5 mm hole spacing
3rd row: 0.2 mm hole spacing
   All the square holes 99 have an edge length of 15 μm.

After the unstructured back surface of the wafer had been coated with an 8 μm (specimen A) or 18 μm (specimen B) layer of Glas 8329, the wafer was then dry-etched in the hole surfaces as far as the glass. It was possible to successfully observe the success of the etching under a transmitted light microscope.

For all 18 measured areas, a Helium leak test revealed a leak rate of less than 10⁻⁸ mbar l/sec.

The high strength of the glass layer regions despite considerable bending of the wafer during the measurement in the respect measurement area is amazing. Even after conditioning at 200° C., there was no change in the glass structure.

Furthermore, resistance measurements were carried out on the glass layer in accordance with DIN/ISO. The results are given in Table 1.

TABLE 1
Specimen designation: 8329

| | HCl | Na₂O | |
|---|---|---|---|
| Water DIN ISO 719 | consumption | equivalent | |
| Class | [ml/g] | (μg/g) | Comments |
| HGB 1 | 0.011 | 3 | none |
| | Material | Total | Comments/ |
| Acid DIN 12116 | removed | surface | visible |
| Class | [mg/dm²] | area [cm²] | changes |
| 1 W | 0.4 | 2 × 40 | Unchanged |
| As material | | | |
| Alkali DIN ISO | Material | Total | Comments/ |
| 695 | removed | surface | visible |
| Class | [mg/dm²] | area [cm^{2]} | changes |
| A 2 | 122 | 2 × 14 | Unchanged |
| As material | | | |

It will be clear to the person skilled in the art that the embodiments described above are to be understood as examples and that the invention is not restricted to these embodiments, but rather can be varied in numerous ways. without departing from the scope of the invention.

1. A process for producing a product generating diffractive or refractive structures in glass, comprising the steps of:
providing an auxiliary substrate having a structured surface, the structured surface of the defining corresponding negative molds; and
applying a first layer of a first material to the structured surface.

2. The process as claimed in claim 1, further comprising removing the auxiliary substrate.

3. The process as claimed in claim 1, wherein the first material comprises glass or a material similar to glass.

4. The process as claimed in claim 1, wherein the step for applying the first layer comprises a deposition operation.

5. The process as claimed in claim 1, wherein the step for applying the first layer comprises sputtering or evaporating.

6. The process as claimed in claim 1, wherein the step for applying the first layer comprises plasma ion assisted deposition.

7. The process as claimed claim 1, wherein the negative molds find use with optical lenses or channels.

8. The process as claimed in claim 1, further comprising planarizing the first layer.

9. The process as claimed in claim 1, further comprising applying a product substrate.

10. The process as claimed in claim 9, wherein the product substrate comprises glass or a material similar to glass.

11. The process as claimed claim 9, wherein the product substrate is adhesively joined to the first layer.

12. The process as claimed in claim 9, wherein the product substrate is anodically bonded to the first layer.

13. The process as claimed in claim 1, wherein the step of providing the auxiliary substrate comprises structuring a self-supporting carrier formed from a second material directly in the auxiliary substrate.

14. The process as claimed in claim 13, further comprising planarizing the auxiliary substrate prior to the structuring step.

15. The process as claimed in claim 13, wherein structuring the self-supporting carrier comprises at least partially etching away the auxiliary substrate.

16. The process as claimed in claim 1, wherein the step of providing the auxiliary substrate comprises:
providing a carrier made from a second material,
applying a structuring layer to the carrier, and
structuring the structuring layer.

17. The process as claimed in claim 16, wherein the structuring layer comprises a pre-structured film or foil.

18. The process as claimed in claim 16, further comprising applying an intermediate layer between the carrier and the structuring layer.

19. The process as claimed in claim 1, further comprising applying a structuring layer comprising a photoresist or gray scale resist.

20. The process as claimed in claim 16, wherein the structuring step comprises a lithographic process or a mechanical pressing operation.

21. A process for generating microstructures in glass, comprising the steps of:
providing a negative mask having a structured surface; and
depositing a first layer of a first material on the negative mask in order to produce a positive impression of the structured surface of the negative mask in the first layer.

22. The process for producing a product comprising a product substrate having a structured surface comprising the steps of:
providing the product substrate; and
depositing a first layer of a first material, the first layer growing in the direction of the product substrate with respect to the product which is to be produced.

23. An intermediate article of manufacture comprising:
an auxiliary substrate; and
a first layer of a first material joined to the auxiliary substrate, the first layer having a structured surface that faces the auxiliary substrate, and wherein the first layer can be detached from the auxiliary substrate while retaining the structured surface.

24. (canceled)

25. A product having a structured surface comprising:
a product substrate made from a third material; and
a first layer of a first material having the structured surface, the first layer being applied fixedly to the product substrate.

26. The product as claimed in claim 25, wherein the product substrate and the first layer are transparent.

27. The product as claimed in claim 25, wherein the first layer and the product substrate comprise glass or a material similar to glass.

28. The product claimed in claim 25, wherein the first layer comprises a layer produced by deposition.

29. The product as claimed in claim 25, wherein the first layer comprises a layer produced by sputtering or evaporation.

30. The product as claimed in claim 25, wherein the first layer is applied by plasma ion assisted deposition.

31. The product as claimed in claim 25, wherein the structured surface defines optical lenses or channels.

32. The product as claimed in claim 25, wherein the first layer is planarized on a side which is opposite from the structured surface.

33. The product as claimed in claim 25, wherein the first layer and the product substrate are adhesively joined to one another.

34. The product as claimed in claim 25, wherein the first layer and the product substrate are anodically bonded.
